(19) United States
(12) Patent Application Publication
(10) Pub. No.: US 2025/0209854 A1
(43) Pub. Date: Jun. 26, 2025

(54) SYSTEM AND METHOD FOR STATIC AND DYNAMIC REAL-TIME GESTURE RECOGNITION

(71) Applicant: Samsung Electronics Co., Ltd., Gyeonggi-do (KR)

(72) Inventors: Sobhan SOLEYMANI, San Diego, CA (US); Razieh KAVIANI BAGHBADERANI, San Jose, CA (US); Yanlin ZHOU, San Diego, CA (US); Dongfang ZHAO, San Diego, CA (US); Yangwen LIANG, San Diego, CA (US); Shuangquan WANG, San Diego, CA (US); Mostafa EL-KHAMY, San Diego, CA (US); Rama Mythili VADALI, Vista, CA (US)

(21) Appl. No.: 18/672,301

(22) Filed: May 23, 2024

Related U.S. Application Data
(60) Provisional application No. 63/613,335, filed on Dec. 21, 2023.

(51) Int. Cl. G06V 40/20

(52) U.S. Cl. CPC G06V 40/20

(57) ABSTRACT

A system and a method are disclosed for performing gesture recognition. A method includes receiving frames of 3D physical body joints; performing a dynamic gesture recognition operation on a window of the frames; performing a static gesture recognition operation on an individual frame among the frames; applying a result of the static gesture recognition operation to a finite-state machine; fusing results of the dynamic gesture recognition operation and the finite-state machine; and generating a final recognized gesture based on the fusing.

### CROSS-REFERENCE TO RELATED APPLICATION

This application claims the priority benefit under 35 U.S.C. § 119(e) of U.S. Provisional Application No. 63/613,335, filed on Dec. 21, 2023, the disclosure of which is incorporated by reference in its entirety as if fully set forth herein.

### TECHNICAL FIELD

The disclosure generally relates to gesture recognition. More particularly, the subject matter disclosed herein relates to improvements to dynamic gesture recognition performance and reduced computational complexity for static gesture recognition.

### SUMMARY

With the recent advances in high-resolution imaging, accurate sensors, and computational power, a variety of human-machine interaction applications have been introduced. For example, extended reality (XR) technology is being developed for digitalization of the world, uncovering a broad spectrum of opportunities across real and virtual-based environments. Hand gesture recognition (HGR), e.g., as an effective communication means for humans, may be an important component for XR applications, which allow for manipulation in virtual environments.

Generally, HGR technologies may be classified as appearance-based, skeleton-based, or point cloud-based. Appearance-based HGR technologies utilize an image of a hand, skeleton-based HGR technologies utilize skeletal joint data captured from sensors, and point cloud-based HGR technologies utilize a 3-dimensional (3D) point cloud of a hand. However, these conventional technologies often have various pre-processing requirements, high computational burdens, and/or are sensitive to illumination and background.

For example, skeleton-based recognition has previously been used in multimedia applications, such as human-computer interaction, human behavior understanding, and medical assistive applications, but most of the existing methods suffer from a large model size and slow execution speed. Further, using multiple large models can increase computational complexity. Also, the length of the gesture as well as how fast the gesture is performed may affect the performance.

Additionally, most of the existing methods consider one network to recognize both static and dynamic gestures.

To overcome these issues, systems and methods are described herein for real-time HGR, which recognizes a set of predefined static and dynamic gestures from a given hand skeleton.

The approaches herein improve on previous methods by providing architecture that utilizes two models that can operate simultaneously on detecting static and dynamic gestures, utilizing Gaussian error linear unit (GELU) activation in the architecture, utilizing depth-wise separable convolutions (DSC) in the architecture, and utilizing state-machines for static gesture recognition to convey more complex gestures.

Additionally, approaches herein improve on previous methods by providing architecture that utilizing a smaller model based on static hand gesture recognition in addition to a relatively larger dynamic hand gesture recognition model to improve performance.

Although embodiments of the disclosure are generally described herein with relation to HGR, other types of gesture recognition may also be performed in relation to other physical body joints. That is, embodiments of disclosure are adaptable to any moving body using models built for them, even though their descriptions herein are made in relation to hand gestures.

In an embodiment, a method includes receiving frames of 3D physical body joints; performing a dynamic gesture recognition operation on a window of the frames; performing a static gesture recognition operation on an individual frame among the frames; applying a result of the static gesture recognition operation to a finite-state machine; fusing results of the dynamic gesture recognition operation and the finite-state machine; and generating a final recognized gesture based on the fusing.

In an embodiment, a system includes a dynamic gesture recognition module configured to perform a dynamic gesture recognition operation on a window of frames of 3D hand joints; a static recognition module configured to perform a static gesture recognition operation on an individual frame among the frames of the 3D physical body joints; a finite-state machine module configured to apply a result of the static gesture recognition operation to a finite-state machine; and a fusing module configured to fuse results of the dynamic gesture recognition operation and the finite-state machine, and generating a final recognized gesture based on the fusing.

### BRIEF DESCRIPTION OF THE DRAWING

In the following section, the aspects of the subject matter disclosed herein will be described with reference to exemplary embodiments illustrated in the figures, in which:

FIG. 1 illustrates a system for performing static and dynamic HGR, according to an embodiment;

FIG. 2 illustrates a lightweight spatio-temporal HGR model for dynamic HGR, according to an embodiment;

FIG. 3 illustrates a finite-state machine for HGR, according to an embodiment;

FIG. 4 illustrates a majority voting module, according to an embodiment;

FIG. 5 is a flowchart illustrating a method for performing static and dynamic HGR, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

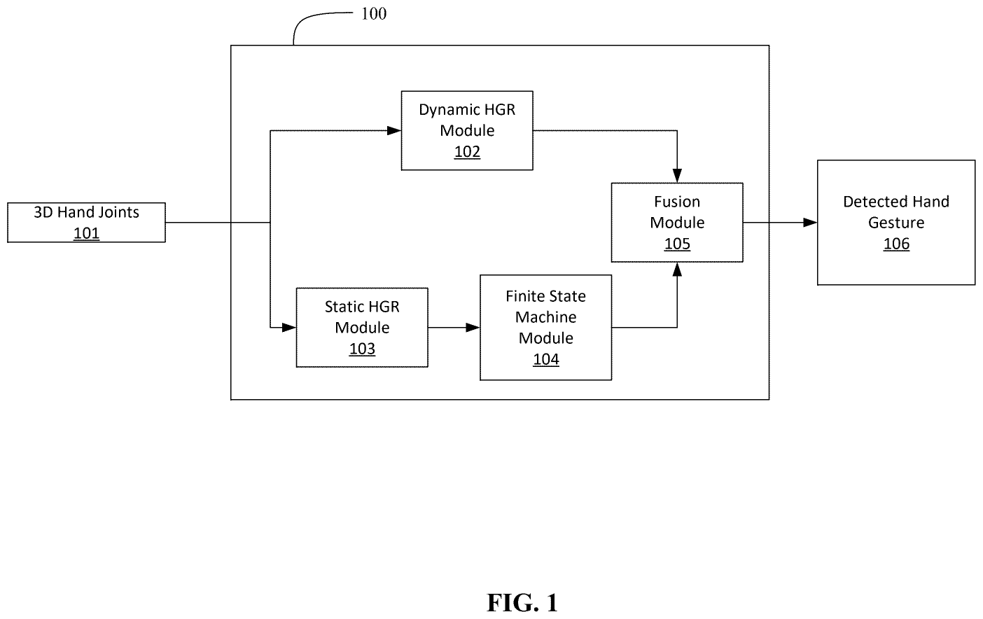

FIG. 1 illustrates a system for performing static and dynamic HGR, according to an embodiment. Although the system of FIG. 1 is described herein as performing HGR, the embodiment is not limited thereto and is adaptable to any recognition of other physical body joints using models built for them.

Referring to FIG. 1, the system 100 includes a dynamic HGR module 102, a static HGR module 103, a finite-state machine module 104, and a fusion module 105. Although each module is illustrates separately in FIG. 1 for convenience of description, the modules may be embodied as one or more processors, or collectively or individually, may be embodied as circuitry that forms part of a larger system, e.g., an IC, an SoC, an assembly, etc.

In operation, frames of detected 3D hand joints are input into the system 100. More specifically, a window of frames are received by the dynamic HGR module 102 and single frames are received by the static HGR module 103.

The dynamic HGR module 102 can recognize both static and dynamic gestures considering the window of frames. The dynamic HGR module 102 may use a lightweight spatio-temporal HGR model for dynamic HGR, which utilizes a depth-wise separable convolution neural network (DSCNN) and GELU activation, e.g., as shown in Equation (1).

$$GELU = xP ( X \leq x ) = x Φ ( x ) \qquad ( 1 )$$

In Equation (1), xϕ(x) is the GELU activation function, where ϕ(x) represents the standard Gaussian cumulative distribution function. GELU nonlinearity weights inputs by their percentile, rather than by gating inputs by their sign as in rectified linear units (ReLUs). As a result, GELU can be thought of as a smoother ReLU.

The GELU activation function in Equation (1) can also be approximated as shown in Equation (2).

$$GELU ( x ) \approx . 5 x ( 1 + tan h [ \sqrt{\frac{2}{π}} ( x + 0.044715 {x}^{3} ) ] ) \qquad ( 2 )$$

The static HGR module 103 makes decisions for the received single frames and then sends these decisions to the finite-state machine module 104, which can recognize a sequence of detected static gestures as a dynamic gesture conveying a complex task. Using the static HGR module 103 and the finite-state machine module 104, static gestures and dynamic gestures that are defined as transitions between multiple states may be recognized, regardless of the length of the gesture or how fast it is performed.

The operations of the dynamic HGR module 102 may be performed at the same time as the operations of the static HGR module 103 and the finite-state machine module 104.

The recognized gestures from the dynamic HGR module 102 and the static HGR module 103 and the finite-state machine module 104 are input to the fusion module 105, which determines a final detected hand gesture 105, based on the results from the dynamic HGR module 102 and the static HGR module 103 and the finite-state machine module 104.

More specifically, when the dynamic HGR module 102 and the static HGR module 103 and the finite-state machine module 104 recognize the same gesture, the fusion module 105 outputs the recognized gesture as the final detected hand gesture 105. However, when the dynamic HGR module 102 and the static HGR module 103 and the finite-state machine module 104 recognize different gestures, the fusion module 105 selects and outputs the recognized gesture with a highest confidence score as the final detected hand gesture 105. For example, confidence scores for each of the branches may be defined and the fusion module 105 makes the decision based on these confidence scores.

More specifically, the confidence score for the static branch, i.e., the static HGR module 103 and finite state machine module 104, may be defined as a product of the confidence scores of a current frame and the maximum confidence scores of each of the previous states in the path to current state. The confidence of each state may be defined as a maximum of softmax probability scores of the state with respect to the path resulting in the current class label and the confidence score for the current frame may be defined as a maximum softmax probability score of the current frame.

The confidence of a dynamic branch may be defined as the maximum softmax probability score obtained from the dynamic HGR module 102.

For example, at each time step, the dynamic HGR module 102 makes a determination considering the window of previous frames of length equal to a window length and the static HGR module 103 makes a determination based on the current frame.

The window of the dynamic HGR module 102 shifts for one frame at each time step (stride=1).

According to the above-described embodiment, simultaneous skeleton-based static and dynamic HGR may be performed, which is robust to lighting conditions and background due to the use of 3D hand joints as input and is able to recognize both static and dynamic gestures with high confidence. Additionally, by using a multi-state static HGR that utilizes a finite-state machine module, the disclosure provides a system that is low in computational complexity and recognizes static hand gestures based on single frames that can be combined to convey more complicated gestures and is not dependent on the length of the gesture or how fast the gesture is performed.

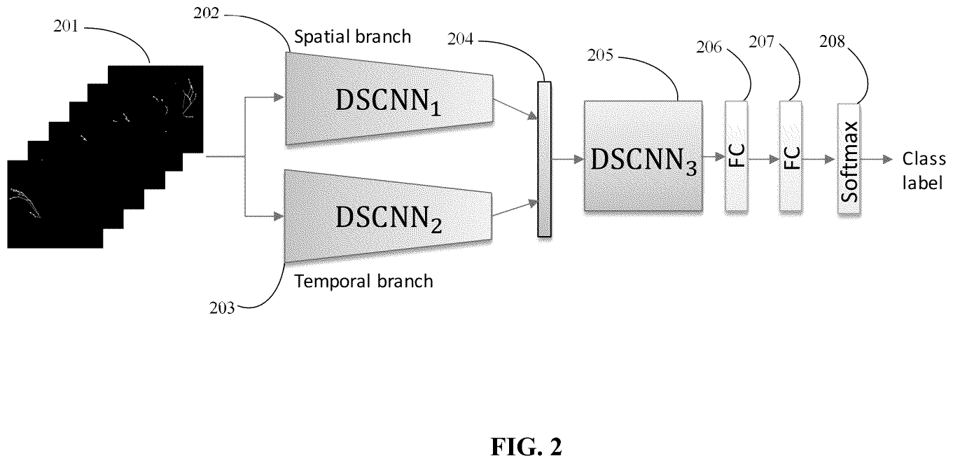

FIG. 2 illustrates a lightweight spatio-temporal HGR model for dynamic HGR, according to an embodiment. For example the model illustrated in FIG. 2 may be used by the dynamic HGR module 102 illustrated in FIG. 1.

Referring to FIG. 2, a window of frames 201 are parallel processes in a spatial branch 202 and a temporal branch 203. The spatial branch 202 uses a DSCNN₁ to filter spatial features of the frames, e.g., joint distance, and the temporal branch 203 uses a DSCNN₂ to filter temporal features of the frames, e.g., joint velocity. As described above, GELU activation may be used in the DSCNNs.

The results of the spatial branch 202 and the temporal branch 203 are then concatenated at 204, and additional DSCNN₃ filtering is performed at 205. The modules 202, 203, and 205 are different networks, although all three utilize DSCNN.

The output of the DSCNN₃ 205 is provided to fully connected (FC) layers 206 and 207, which apply weights to predict a correct label. Thereafter, a softmax layer (or module) 208 provides final probabilities for each label.

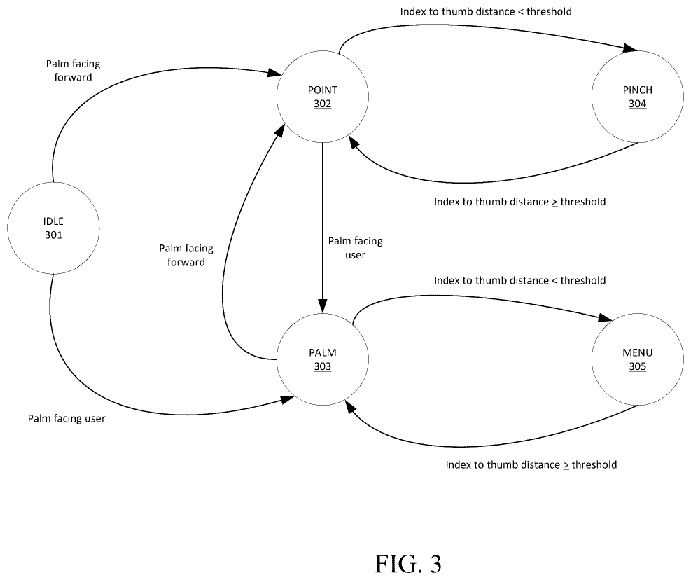

FIG. 3 illustrates a finite-state machine for HGR, according to an embodiment. For example the finite-state machine illustrated in FIG. 3 may be used by the finite-state machine module 104 illustrated in FIG. 1.

Referring to FIG. 3, an example is provided in which a dynamic gesture of a user moving their index finger closer to their thumb, i.e., a pinch motion, is recognized from a sequence of static gestures as indicating a pinching gesture, e.g., for selecting an object in an image, or for displaying a menu.

More specifically, stating from an idle state 301, if a user's hand is included in a static frame, with palm facing forward, i.e., away from the user, a point state 302 is identified. However, from the idle state 301, if a user's hand is included in a static frame, with palm facing the user, a palm state 302 is identified. Transition between the point state 302 and the palm state 302 may also occur based on a subsequent static frame including the palm facing forward or the palm facing the user.

From the point state 302, wherein the user's palm is facing forward, when a distance between the index finger and the thumb is less than a predetermined threshold in a subsequent frame, a pinch state 304 is identified.

From the pinch state 304, when the distance between the index finger and the thumb is greater than the predetermined threshold in a subsequent frame, the point state 302 is identified.

From the palm state 303, wherein the user's palm is facing the user, when a distance between the index finger and the thumb is less than the predetermined threshold in a subsequent frame, a menu state 305 is identified. That is, the pinch is recognized a command for displaying a menu.

From the menu state 305, when the distance between the index finger and the thumb is greater than the predetermined threshold in a subsequent frame, the palm state 303 is identified.

As described above, according to an embodiment, using a finite-state machine for HGR, a sequence of static gestures can convey a complex task.

Additionally, because the static gesture recognition considers decisions for single frames, static and dynamic gestures that are defined as transitions between multiple states may be recognized, regardless of the length of a gesture or how fast it is performed.

Additionally, while FIG. 3 is described above with reference to one example of a finite state machine, the disclosure is not limited to this example. Instead, the present disclosure is also applicable to other finite state machines with different structures, states, and gesture classes.

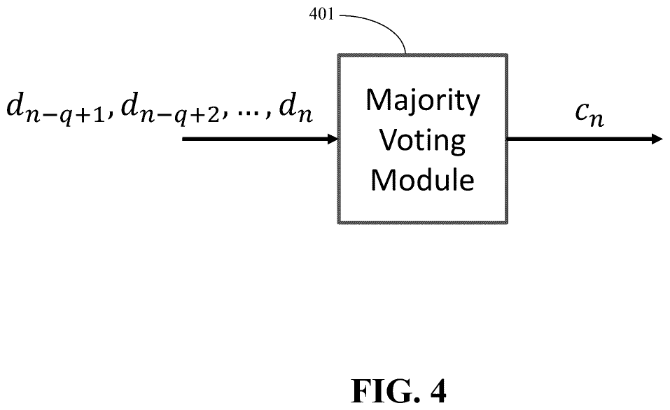

FIG. 4 illustrates a majority voting module, according to an embodiment.

Referring to FIG. 4, to perform post-processing on single-frame decisions, e.g., an output of the static HGR module 103 illustrated in FIG. 1, to remove the effect of noise, a majority voting module 401 may be implemented to perform majority voting on a queue of per frame decisions, where a length of the queue can be either fixed or a function of the frame rate. For example, the majority voting module 401 may be include between the static HGR module 103 and the finite-state machine module 104 illustrated in FIG. 1.

As illustrated in FIG. 4, dᵢ,n−q+1≤i≤n represents the per frame decisions, q represents a length of the queue, i.e., the number of frames included in the queue, and cₙ represented a gesture for a current frame as a result of post-processing the decisions for the q frames. Using majority voting module 401, the final prediction cₙ is determined by the class label that receives the majority of votes. In case of no majority, “no gesture” is assigned.

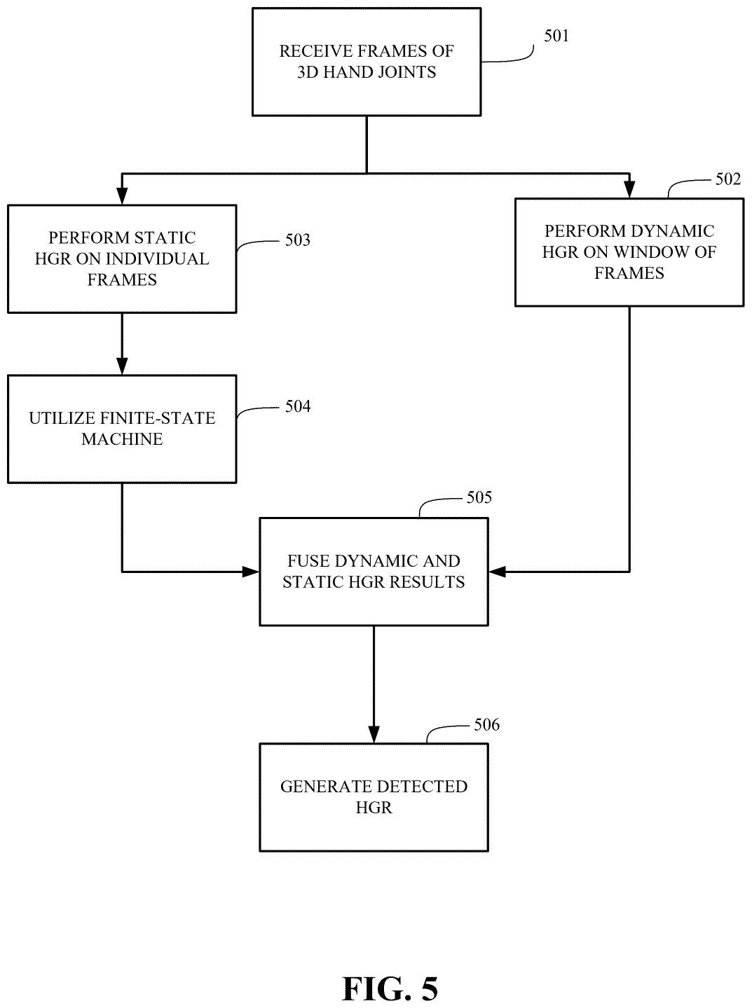

FIG. 5 is a flowchart illustrating a method for performing static and dynamic HGR, according to an embodiment. For example, the method illustrated in FIG. 5 may be performed by the system illustrated in FIG. 1.

Referring to FIG. 5, in step 501, frames of detected 3D hand joints are received.

In step 502, dynamic HGR is performed on a window of the frames. For example, a lightweight spatio-temporal HGR model may be used for dynamic HGR, which utilizes a DSCNN and GELU activation, e.g., as illustrated in FIG. 2 and described above.

In step 503, static HGR is performed for individual frames.

In step 504, the static HGR results are applied to a finite-state machine, e.g., as illustrated in FIG. 3, which can recognize a sequence of detected static gestures as a dynamic gesture conveying a complex task.

Although FIG. 5 illustrates step 502 and steps 503 and 504 occurring in a parallel, e.g., at the time, the present disclosure is not limited thereto. Alternatively, although possibly not as efficient, steps 502, 503, and 504 may be performed in series.

Additionally, although not illustrated in FIG. 5, as described above with reference to FIG. 4, to perform post-processing on the single-frame decisions for step 503, e.g., to remove the effect of noise, majority voting may be performed, between steps 503 and 504, on a queue of per frame decisions, where a length of the queue can be either fixed or a function of the frame rate.

In step 505, the results of step 502 and steps 503 and 504 are fused, in order to determine and a final detected hand gesture in step 506.

More specifically, when step 502 and steps 503 and 504 recognize the same gesture, the recognized gesture is output as the final detected hand gesture in step 506. However, when step 502 and steps 503 and 504 recognize different gestures, the recognized gesture with a highest confidence score is determined in step 505 and generated as the final detected hand gesture in step 506.

According to the above-described embodiments, simultaneous skeleton-based static and dynamic gesture recognition may be performed, which is robust to lighting conditions and background due to the use of 3D physical body joints as input and is able to recognize both static and dynamic gestures with high confidence. Additionally, by using a multi-state static gesture recognition that utilizes a finite-state machine module, the disclosure provides a system that is low in computational complexity and recognizes static gestures based on single frames that can be combined to convey more complicated gestures and is not dependent on the length of the gesture or how fast the gesture is performed.

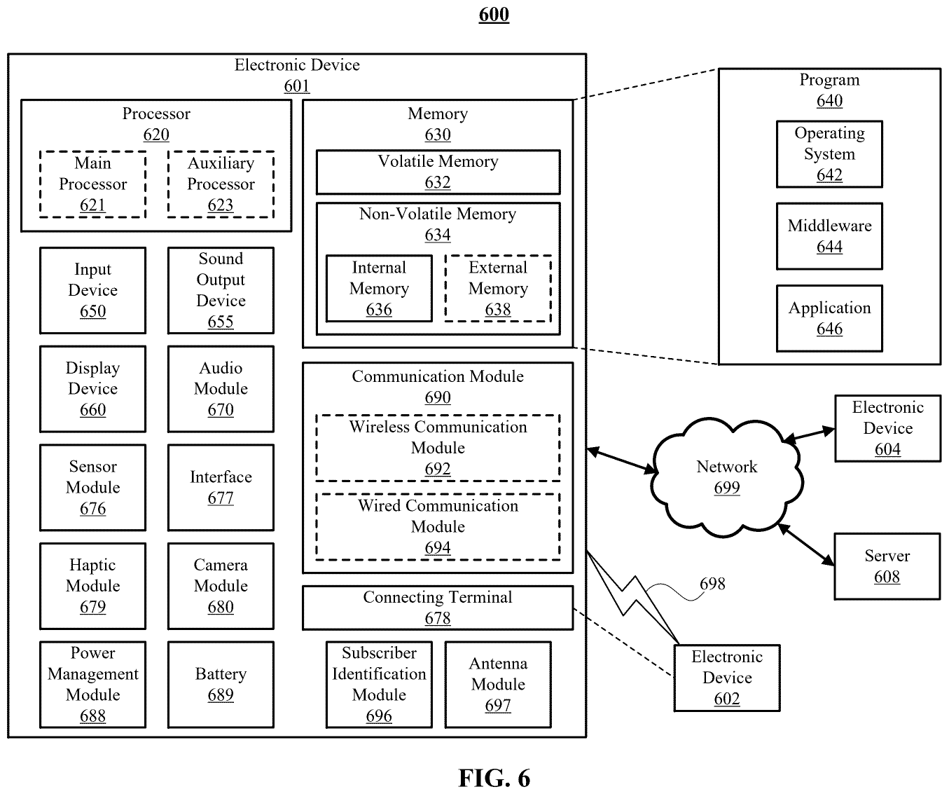

FIG. 6 is a block diagram of an electronic device in a network environment 600, according to an embodiment. For example, an electronic device 601 as illustrated in FIG. 6 may be an XR (i.e., virtual reality (VR), augmented reality (AR), or mixed reality (MR)) headset that may be wirelessly tethered to an external computer, e.g., an electronic device 602, and performs static and dynamic HGR, e.g., according to the method illustrates in FIG. 5.

Referring to FIG. 6, the electronic device 601 in a network environment 600 may communicate with the electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™ wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
receiving frames of 3-dimensional (3D) physical body joints;
performing a dynamic gesture recognition operation on a window of the frames;
performing a static gesture recognition operation on an individual frame among the frames;
applying a result of the static gesture recognition operation to a finite-state machine;
fusing results of the dynamic gesture recognition operation and the finite-state machine; and
generating a final recognized gesture based on the fusing.

2. The method of claim 1, wherein at least a portion of performing the dynamic gesture recognition operation overlaps in time with at least one of at least a portion of performing the static gesture recognition operation or at least a portion of applying the result the static gesture recognition operation to the finite-state machine.

3. The method of claim 1, wherein performing the dynamic gesture recognition operation comprises utilizing a lightweight spatio-temporal gesture recognition model.

4. The method of claim 3, wherein the lightweight spatio-temporal gesture recognition model utilizes a depth-wise separable convolution neural network (DSCNN).

5. The method of claim 3, wherein the lightweight spatio-temporal gesture recognition model utilizes Gaussian error linear unit (GELU) activation.

6. The method of claim 1, wherein fusing the results of the dynamic gesture recognition operation and the finite-state machine comprises:
comparing the results of the dynamic gesture recognition operation and the finite-state machine;
in response to the results of the dynamic gesture recognition operation and the finite-state machine matching, selecting the matching result as the final recognized gesture; and
in response to the results of the dynamic gesture recognition operation and the finite-state machine not matching, selecting a result having a highest confidence score among the results of the dynamic gesture recognition operation and the finite-state machine as the final recognized gesture.

7. The method of claim 1, further comprising performing post-processing on the result of the static gesture recognition operation before applying to the finite-state machine.

8. The method of claim 7, wherein performing post-processing on the result of the static gesture recognition operation comprises performing majority voting on a queue of per frame decisions of the static gesture recognition operation.

9. The method of claim 8, wherein a length of the queue is fixed.

10. The method of claim 8, wherein a length of the queue is determined as a function of a frame rate.

11. A system, comprising:
a dynamic gesture recognition module configured to perform a dynamic gesture recognition operation on a window of frames of 3-dimensional (3D) physical body joints;
a static gesture recognition module configured to perform a static gesture recognition operation on an individual frame among the frames of the 3D physical body joints;
a finite-state machine module configured to apply a result of the static gesture recognition operation to a finite-state machine; and
a fusing module configured to fuse results of the dynamic gesture recognition operation and the finite-state machine, and generating a final recognized gesture based on the fusing.

12. The system of claim 11, wherein at least a portion of performing the dynamic gesture recognition operation overlaps in time with at least one of at least a portion of performing the static gesture recognition operation or at least a portion of applying the result the static gesture recognition operation to the finite-state machine.

13. The system of claim 11, wherein the dynamic gesture recognition module is further configured to perform the dynamic gesture recognition operation utilizing a lightweight spatio-temporal gesture recognition model.

14. The system of claim 13, wherein the lightweight spatio-temporal gesture recognition model utilizes a depth-wise separable convolution neural network (DSCNN).

15. The system of claim 13, wherein the lightweight spatio-temporal gesture recognition model utilizes Gaussian error linear unit (GELU) activation.

16. The system of claim 11, wherein the fusing module is further configured to fuse the results of the dynamic gesture recognition operation and the finite-state machine by:
comparing the results of the dynamic gesture recognition operation and the finite-state machine;
in response to the results of the dynamic gesture recognition operation and the finite-state machine matching, selecting the matching result as the final recognized gesture; and
in response to the results of the dynamic gesture recognition operation and the finite-state machine not matching, selecting a result having a highest confidence score among the results of the dynamic gesture recognition operation and the finite-state machine as the final recognized gesture.

17. The system of claim 11, further comprising a post post-processing module configured to perform post-processing on the result of the static gesture recognition operation before being applied to the finite-state machine module.

18. The system of claim 17, wherein the post post-processing module includes a majority voting module configured to perform majority voting on a queue of per frame decisions of the static gesture recognition module.

19. The system of claim 18, wherein a length of the queue is fixed.

20. The system of claim 18, wherein a length of the queue is determined as a function of a frame rate.
